(19) United States
(12) Patent Application Publication
(10) Pub. No.: US 2017/0325625 A1
(43) Pub. Date: Nov. 16, 2017

(54) STEAMER

(71) Applicant: DAVID MENASHES, HAIFA (IL)

(72) Inventor: DAVID MENASHES, HAIFA (IL)

(21) Appl. No.: 15/662,989

(22) Filed: Jul. 28, 2017

Related U.S. Application Data
(63) Continuation-in-part of application No. 14/402,864, filed on Nov. 21, 2014.
(60) Provisional application No. 61/649,398, filed on May 21, 2012.

(51) Int. Cl. A47J 31/44; F22B 1/28; A47J 27/21

(52) U.S. Cl. CPC A47J 31/4489; A47J 27/21016; F22B 1/282

(57) ABSTRACT

A steamer has a steam mode and hot liquid mode, incorporated within a drinking liquid appliance comprising an electrical setup; at least one first tube, having one first end and one first exit and at least one second tube, having one second end and one second exit; at least one heating element, coupled with the electrical setup, wrapped around tubes selected from a group comprising of: the at least one first tube; the at least one second tube; and a combination thereof; a steam delivery apparatus, having a nozzle, wherein the steam delivery apparatus is coupled with the electrical setup configured to activate the steamer in the steam mode by rotating the apparatus, wherein the second exit is fluidically connected to the steam delivery apparatus; a valve coupled with the electrical setup configured to route fluid to the first end in the hot liquid mode and to the second end in the steam mode; and wherein fluid routed to the end yield hot liquid via a liquid nozzle connected to the first exit, and wherein fluid routed to the second end yield steam via the second exit.

### CROSS REFERENCE TO RELATED APPLICATIONS

This patent application is a continuation-in-part of co-pending U.S. patent application Ser. No. 14/402,864, filed Nov. 21, 2014, which in turn is a U.S. National Phase filing of PCT Patent Application No. PCT/IL2013/050442, filed May 21, 2013, which is based on and claims the benefit of the filing date of U.S. Provisional Patent Application Ser. No. 61/649,398, filed May 21, 2012, each of which is incorporated herein by reference in its entirety.

### TECHNICAL FIELD

The present disclosed subject matter relates to thermodynamics. More particularly, the present disclosed subject matter relates to fluid heating.

### BACKGROUND

PCT Publication No. WO2009047772 to the inventor describes a steam generating mechanism incorporated within a water heating system having a body, at least one heating element, on/off switch and power supply, the steam generating mechanism comprising: a hollow tube having a first side and a second side provided close to the at least one heating element; a one way valve connected to said first side, wherein said one way valve allows water to enter into said hollow tube; a one directional pump connected to said second side, wherein the pump is capable of discharging steam generated within said hollow tube; a pipe fluidly connected to said one directional pump wherein said pipe passes through the body for discharging said steam outwardly.

An object of the present invention is to provide improved steam generating devices for the steam generating mechanism of Publication No. WO2009047772 as well as other systems and apparatuses.

### BRIEF SUMMARY OF THE INVENTION

According to a first aspect of the present disclosed subject matter, a steamer having a steam mode and hot liquid mode, incorporated within a drinking liquid appliance comprising: an electrical setup; at least one first tube, having one first end and one first exit and at least one second tube, having one second end and one second exit; at least one heating element, coupled with the electrical setup, wrapped around tubes selected from a group comprising of: the at least one first tube; the at least one second tube; and a combination thereof; a steam delivery apparatus, having a nozzle, wherein the steam delivery apparatus is coupled with the electrical setup configured to activate the steamer in the steam mode by rotating the apparatus, wherein the second exit is fluidically connected to the steam delivery apparatus; a valve coupled with the electrical setup configured to route fluid to the first end in the hot liquid mode and to the second end in the steam mode; and wherein fluid routed to the end yield hot liquid via a liquid nozzle connected to the first exit, and wherein fluid routed to the second end yield steam via the second exit.

In some exemplary embodiments, the steamer further comprises an exit valve, coupled with the electrical setup, configured to route steam to the first exit, in steam mode, and to route hot liquid, to the first exit, in hot liquid mode.

In some exemplary embodiments, the steamer further comprises a return valve, coupled with the electrical setup, configured to route fluid from the first tube to the second tube and exit trough the second end into a check valve configured to provide steam trough a third exit, in a power saving mode, and wherein the third exit is fluidically connected to the steam delivery apparatus.

In some exemplary embodiments, the exit valve is configured to provide hot liquid trough the first exit while steam is simultaneously provided through the third exit, in concurrent mode.

In some exemplary embodiments, the steamer further comprises a pump capable of pressurizing fluid trough an entry to the valve, wherein the pump is coupled with the electrical setup.

In some exemplary embodiments, the at least first tube and the at least second tube are casted within a heating block, wherein the first and second tubes are thermally connected to the heating block, wherein the at least one heating element is thermally connected to the heating block and wherein the heater has a heating capacity sufficient to convert water entering the second tube into steam leaving via the second exit.

In some exemplary embodiments, the tubes are casted within the heating block in a formation that provides optimal thermal connectivity, and wherein the formation is selected from a group comprising of: the second tube wrapped around the first tube; the second tube inserted within the first tube; the second tube and the first tube are parallel to one another; and a combination thereof.

In some exemplary embodiments, the steam delivery apparatus is connected to the steamer by a hinge and wherein the steam delivery apparatus can be inserted within a dent in the body of the steamer and being rotated outwardly.

In some exemplary embodiments, the steamer further comprises a protecting thermostats-based mechanism mutually operable with the electric setup.

In some exemplary embodiments, the protecting thermostats-based mechanism provides functions selected from a group comprising of: security function in which the system is disconnected from electricity; maintaining temperature of fluid inside the at least one first tube at about 65 degrees C.; maintaining temperature of fluid inside the at least one second tube at about 99 degrees C.; and a combination thereof.

In some exemplary embodiments, the steamer further comprises a plurality of indicators coupled with the electrical setup, wherein indicators of the plurality of indicators are configured to indicate a status of the steamer and wherein the status is selected from a group comprising of: steam mode; hot liquid mode; power saving mode; concurrent mode; power on; steamer ready; and a combination thereof.

In some exemplary embodiments, the steamer is an integral part of a water heating container selected from a group comprising of: an urn; a kettle; a coffee maker; an espresso machine; and a combination thereof and wherein hot liquid exits into the container.

According to another aspect of the present disclosed subject matter, a steamer having a steam mode and hot liquid mode, incorporated within a drinking liquid appliance comprising an electrical setup; a heating block having a first fluid passage and a second fluid passage, wherein the first and the second passages are formed as a maze inside the heating block and wherein the first passage has a first end and a first exit and the second passage has a second end and a second exit; at least one heating element, coupled with the electrical setup, thermally connected to the heating block, and wherein the heater has a heating capacity sufficient to convert fluid in the second passage into steam; a steam delivery apparatus, having a nozzle, wherein the steam delivery apparatus is coupled with the electrical setup configured to activate the steamer in the steam mode by rotating the apparatus, wherein the second exit is fluidically connected to the steam delivery apparatus; a valve coupled with the electrical setup configured to route fluid to the first end in the hot liquid mode and to the second end in the steam mode; and wherein fluid routed to the first end yield hot liquid via a liquid nozzle connected to the first exit, and wherein fluid routed to the second end yield steam via the second exit.

In some exemplary embodiments, the steamer of, further comprising baffles within the passages to provide optimal thermal connectivity with the fluid.

In some exemplary embodiments, the steamer further comprises an exit valve, coupled with the electrical setup, configured to route steam to the first exit, in steam mode, and to route hot liquid, to the first exit, in hot liquid mode.

In some exemplary embodiments, the steamer further comprises a return valve, coupled with the electrical setup, configured to route fluid from the first passage to the second passage and exit trough the second end into a check valve configured to provide steam trough a third exit, in a power saving mode, and wherein the third exit is fluidically connected to the steam delivery apparatus.

In some exemplary embodiments, the exit valve is configured to provide hot liquid trough the first exit while steam is simultaneously provided through the third exit, in concurrent mode.

In some exemplary embodiments, the steamer further comprises a pump capable of pressurizing fluid trough an entry into the valve, wherein the pump is coupled with the electrical setup.

In some exemplary embodiments, the steamer further comprises a protecting thermostats-based mechanism mutually operable with the electric setup, wherein the protecting thermostats-based mechanism provides functions selected from the group consisting security function in which the system is disconnected from electricity; maintaining temperature of fluid inside the at least one first passage at about 65 degrees C.; maintaining temperature of fluid inside the at least one second passage at about 99 degrees C.; and a combination thereof.

In some exemplary embodiments, the steamer further comprises a plurality of indicators coupled with the electrical setup, wherein indicators of the plurality of indicators are configured to indicate a status of the steamer and wherein the status is selected from a group comprising of: steam mode; hot liquid mode; power saving mode; concurrent mode; power on; steamer ready; and a combination thereof.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 describes a tube having a variable inner diameter and various widgets capable of impeding flow;

FIG. 2 shows two tubes, one inside the other;

FIG. 3A depicts pressurized water entering a steam-heating tube in the form of drops;

FIG. 3B is a drawing of a special nozzle to provide water to the tube;

FIG. 3C depicts another special nozzle in such tube;

FIG. 3D shows a steam heating tube with special baffles to increment heating of the water;

FIG. 3E illustrates revolving baffles in the tube;

FIG. 3F shows three examples of baffles in a tube;

FIG. 4 is a schematic diagram of an electrical circuit for heating water to steam in a tube;

FIG. 5 is an exploded view of a percolator with a steamer;

FIG. 6 is an exploded view of a kettle with a steamer;

FIG. 7 is an exploded view of a water bar with a steamer;

FIG. 8 shows in perspective view vertical heating element and matching tube, and nozzles and an electrostat;

FIG. 9 shows in perspective view a horizontal heating element and matching tube, and nozzles and an electrostat.

FIGS. 10A-C schematically depicts several topologies of a heating block, in accordance with some exemplary embodiments of the disclosed subject matter; and

FIGS. 11A and 11B illustrates a steam delivery apparatus in extracted and retracted position respectively, in accordance with some exemplary embodiments of the disclosed subject matter.

### DETAILED DESCRIPTION OF THE INVENTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

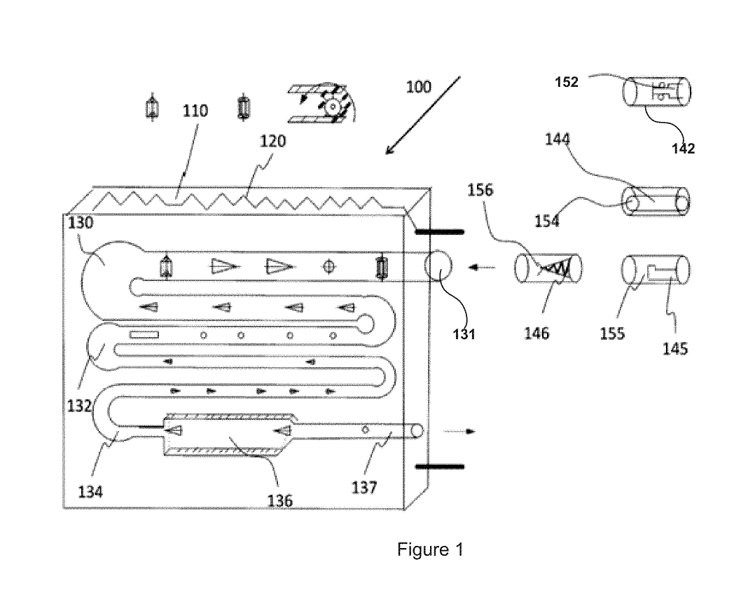

FIG. 1 shows in a schematic drawing a steam heater 100 embodiment. The steam heater includes a heating block 110, a heating element 120, a tube 130, nozzles and baffles, the latter will be described below. The heater 100 also includes a pump, not shown, which feeds pressurized water to the tube 130 and/or siphons steam out of the tube 130. The heater also includes an electrical system discussed below.

The steam heater may be placed under or inside the base of a kettle, in which case the block is typically heated at 1300-2300 Watts.

The entrance 131 of the tube 130 is typically 3-4 mm i.d.; however, the exit 137 is typically 1-3 mm i.d., more preferably 1-2 mm. However, the tube 130 may also have a constriction 134 before an expansion 136, all of these restrictions and expansions may serve to increase heat transfer from the tube 130 to water therein passing from the entrance 131 to the exit 137.

The water is fed to the heater 100 by a pump and/or by gravitation, the water entering the tube via at least one nozzle. One nozzle 142 has a sealed end 152, and openings facing inner walls of the tube entrance 131. Another nozzle 144 has an opening 154 that is as wide as the hole along the nozzle; yet another nozzle 145 has also openings facing the walls of the tube, but has less dead volume than nozzle 142. Nozzle 146 is screw-shaped, with holes along the thread, which may help make the flow of water more turbulent and thus increase the heating rate of the water passing through.

In preferred embodiments, the tube 130 includes at least one coil. In some embodiments, not shown, the steam heater includes a maze structure through which the water/steam passes; the maze may be constructed from two blocks of heating elements that match each other in grooves and ridges or one block only with a maze structure, which is sealed with a matching plate. Some embodiments may include more than one maze, for example a heating block may be sandwiched in between mazes, such that the water entering a first maze from its periphery goes to a centre point of the maze, having passed through the entire maze first, and then leaves the first maze through a passage which extends from said centre, throughout the heating block and into a centre of a second maze, the water then passing through the entire second maze before exiting as steam. Such heater may include therein the nozzles described above as well as similar nozzles, and baffles discussed below, to further facilitate heat transfer to the water passing through the maze.

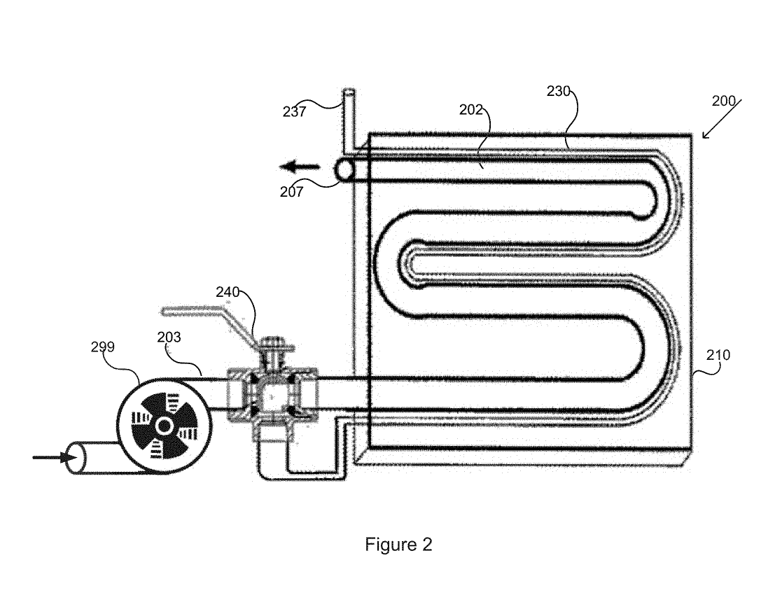

Another embodiment is depicted in FIG. 2. The heater 200 again includes a heating block 210, a heating element (not shown), a tube 202, nozzles and baffles. In some exemplary embodiments, heater 200 may include a pump 299 that feeds pressurized water via entry 203 to a first tube 202 and second tube 230. In some embodiments, a valve 240 may be utilized for routing the water from entry 203 to either first tube 202 or to second tube 230. A user may manipulate valve 240 or a switch operationally coupled to the valve 240, to select between hot water delivery from the first tube 202, for example for delivery to the kettle or directly to a cup, and steam delivery trough second tube 230. In some exemplary embodiments, a booster pump (not shown), preferably between the valve 240 and the second tube 230 may be used to boost the water pressure in the second tube 230. In some embodiments the booster pump automatically operates whenever the switch is set to deliver water to the second tube 230, e.g., by the same switch that sets for delivery of hot water from the first tube. In other embodiments the booster pump can be selected to be operated independently from the valve; preferably, in such embodiments, there is a micro-switch to prevent the booster pump from operating when the valve is set to deliver hot water not to the second tube. In some embodiments, the second tube 230 is coiled around the first tube 202.

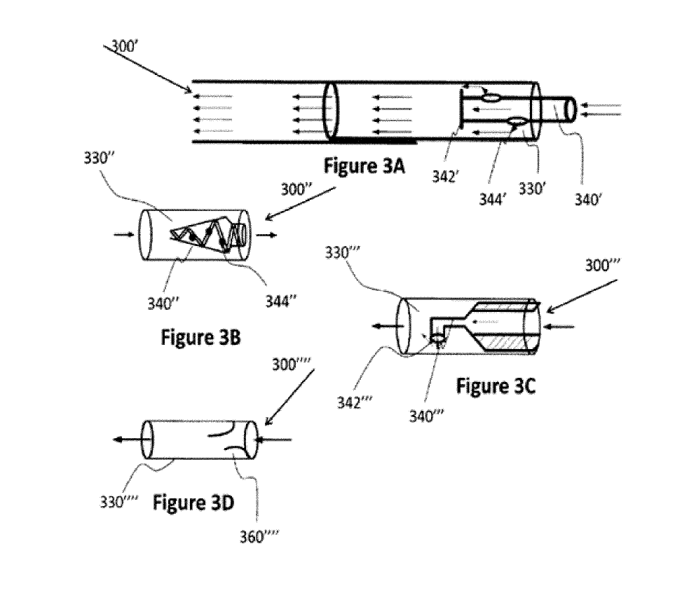

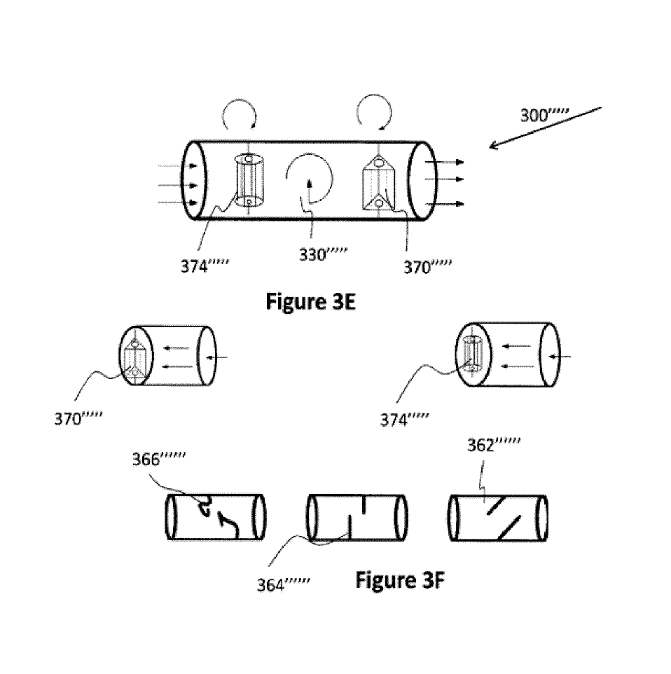

The heater also includes an electrical system discussed below. FIG. 3A is a schematic drawing showing part of a heater 300′ with steam tube 330′. The nozzle 340′ is blocked at the end, and has a rim 342′ that extends around the nozzle to leave a narrow space between the inner walls of the tube 330′ and the nozzle 340′. Holes 344′ allow water to exit the nozzle 340′ and impinge upon the inner walls of the tube 330′, before passing through the narrow space.

In the embodiment 300″ the nozzle 340″ is corkscrew-shaped, also blocked at end and with holes 344″, the corkscrew shape and the position of the holes allowing the water to become turbulent, and/or go a long and tortuous path, to facilitate heating of the water, and the water essentially impinges upon the inner walls of the tube 330″.

In another heater 300′″, nozzle 340′″ has a very small-bore end 342′″, open and directed to one spot on the wall. Such spot may be locally heated more than other areas of the tube 330′″.

Heater 300″″ includes in the tube 330″″ stationary baffles 360″″. The baffles 360″″ are preferably opposed to each other to create a narrow space through which the water passes in the tube 330″″.

In another embodiment 300′″″ shown in FIG. 3E shows rotational baffles 370′″″ and/or 374′″″ that are installed in the tube 330′″″. The first baffle 370′″″ is prism-shaped, whereas the second baffle 374′″″ is wheel-shaped. Preferably, the baffles have ridges on surfaces thereof, to facilitate interaction with water passing by the baffles, to further heat the water. Preferably, the baffles are installed in a maze-shaped heating block rather than in a tube, in regard of ease of construction.

As shown in FIG. 3F, three types of stationary baffles 362″″″, 364″″″, 366″″″ are shown. According to the requirements such as energy expenditure efficiency, heater size requirements and restrictions, steam temperature and delivery rate, one or more baffle may be selected.

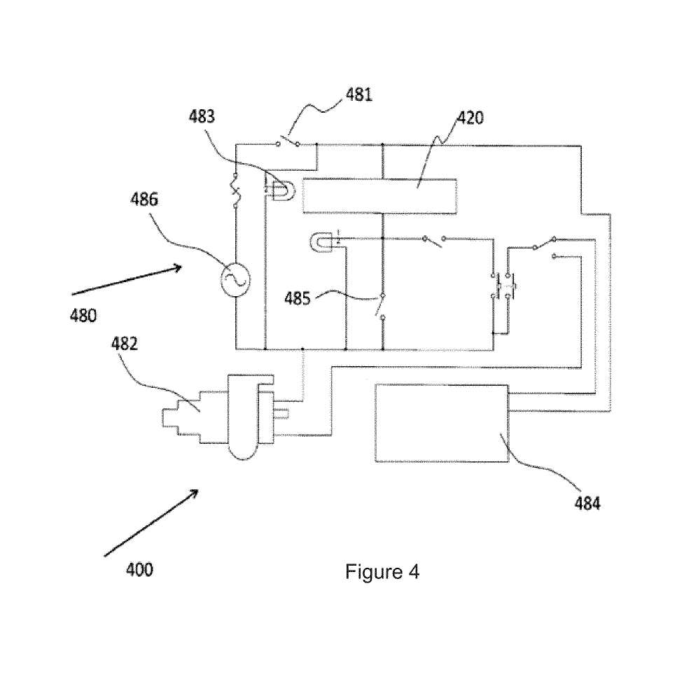

FIG. 4 shows an electrical setup 480 suitable for use in a steam heater embodiment 400. The electrical setup 480 includes the heating element 420, switches 481, a pump 482, indicating lamps 483, a PCB 484, at least one thermostat 485, power supply 486.

Preferably, the electrical setups are set to bring the steam to a certain temperature, in order to optimize the steam for its designated purpose, e.g. to prepare milk froth for coffee. The steam heaters may be incorporated in an electric kettle, or a percolator, or milk frothier, or a water bar such as Tami 4®, etc.

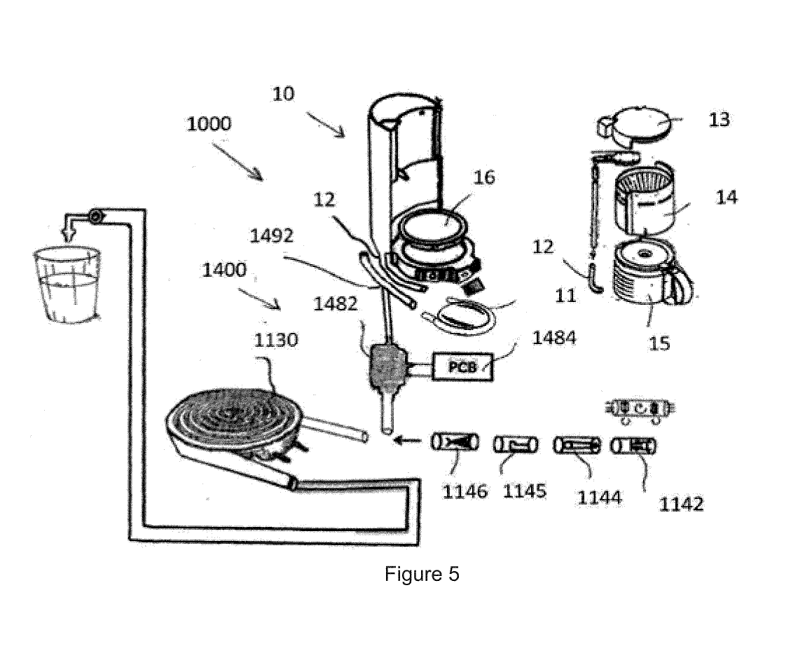

FIG. 5 shows in an exploded view a modified percolator 1000. The percolator has the known container 10, a heater 11 in contact with a steam pipe 12, lid 13, filter holder 14 and coffee receptacle 15 that sits on a holding plate 16. The steamer 1400 comprises a junction 1492, leading from pipe 12 to pump 1482, which when operated provides water to the maze 1130 via a nozzle such as one of nozzles 1142-1146.

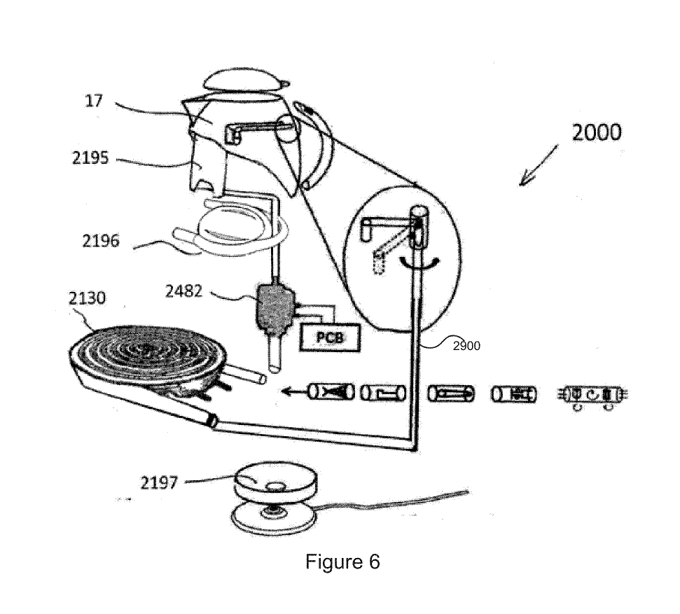

FIG. 6 depicts a modified kettle 2000. The kettle 2000 includes a body 17 that is shown in cutout view. A cold-water container 2195 (also shown in cutout view) is situated inside the body 17 that is thermally insulated from the space inside the body 17 and outside the container 2195 such that the water therein is less than 50° C. The kettle has a plate 2196 that in commercially available kettles holds a heating element and seals the bottom of the body 17. However, in contrast to the commercially available plates, plate 2196 has an aperture which allows to fluidly connect the container 2195 with the steamer pump 2482. Water goes from the pump 2482 to the maze 2130. The maze may fit into a bottom plate 2197.

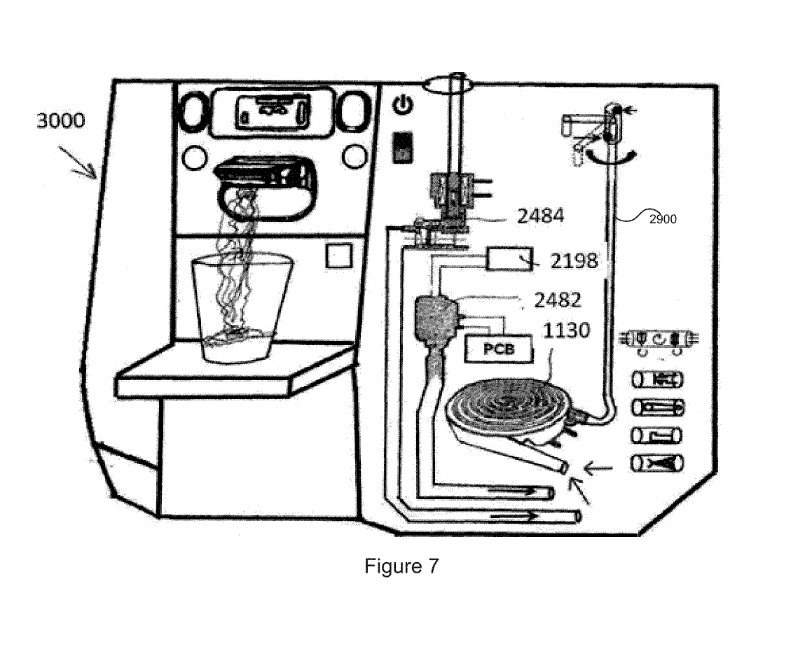

FIG. 7 shows a modified water bar 3000 in which water can be provided for steaming from mains via an electric or manual (or magnetic, etc) valve to maze 1130, or from a reservoir 2484 via a pump 2482 to the maze 1130.

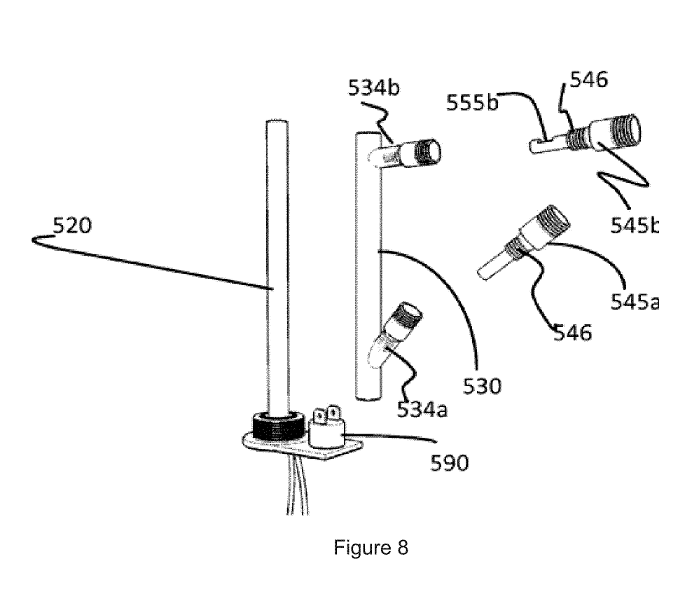

FIG. 8 shows in perspective view a vertical heating element 520 and matching tube 530, and nozzles 545a and 545b and an electrostat 590. The element 520 is vertical in respect to a kettle base (not shown). Water enters via the bottom nozzle 545a, which has an opening (not shown) that faces the heating element 520, i.e. in this particular case the nozzle does have an opening at the end, as the water generally flows in the tube 530 in a different direction. The opening 555b of the top nozzle 545b, from which the steam exits, preferably faces upwards, which is not strictly opposite the direction of the heating element (vertical) but for practical purposes faces away from the heating element. The nozzles 545a and 545b may have threads 546 that match threads (not shown) on branches 534a and 534b on the tube 530, so as to allow firmly screwing the nozzles 545a, 545b to the tube 530, yet allowing easy removal of the nozzles 545a, 545b for cleaning the tube from dirt, scaling from precipitates, etc.

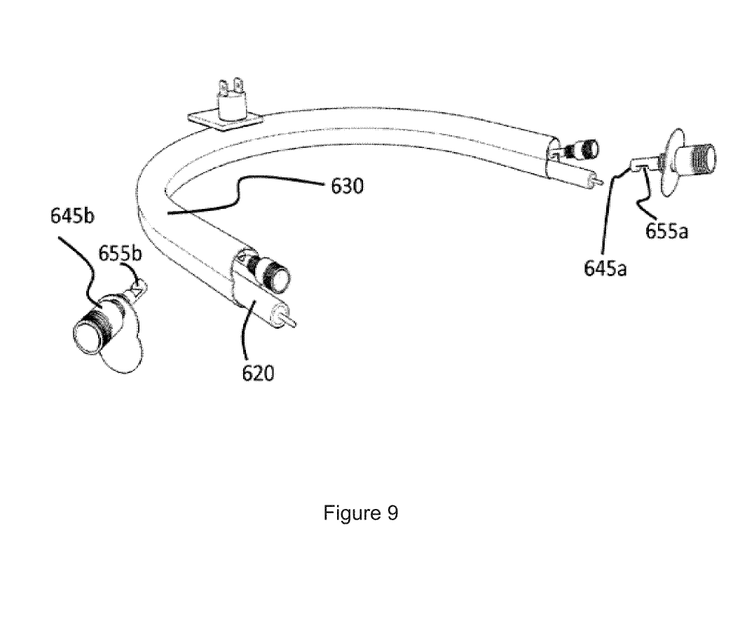

FIG. 9 shows in perspective view a horizontal heating element 620 and matching tube 630, and nozzles 645a and 645b.

The exit nozzles 545b and 645b both have openings 555b and 655b facing upwards, such orientation may help prevent release of liquid from the heater since the liquid may be located mainly at lower parts of the tube 530, 630.

The steam heater with the tubes in horizontal orientation (630) has in preferred kettle embodiments a hollow base (under the body wherein water is normally heated). The heating element and tube is situated inside the base, such that the only access a user has is to a switch operationally coupled to the heater, to allow turning on the steam providing mode. In experiments with such embodiments, wherein the tube 630 was about 250 mm long and had an internal height of 8 mm (between the heating element 520 and the roof of the tube 530 on the inside, the width of the tube typically being somewhat narrower), tap water at about 25° C. was fed by a pump, at a flow rate corresponding to a pressure of about 5 bar. A sufficient amount of steam was produced within 10-20, enough to satisfactorily cream a cup of coffee.

Typically, the heating element 520, 620 has a power of 600-900 W to provide a desirable amount of steam in this embodiment.

While preferred embodiments have been described, the invention is only limited by the scope of the claims.

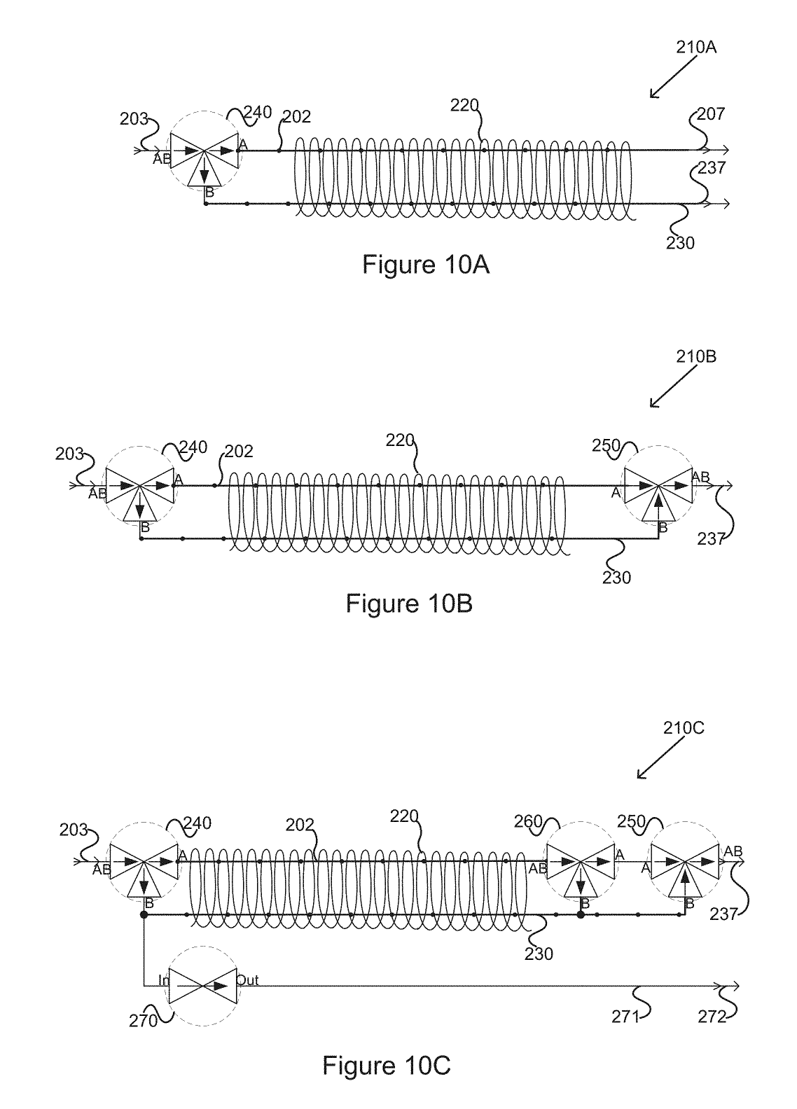

Referring now to FIG. 10A-C, schematically depicting a several topologies of a heating blocks 210A-C, in accordance with some exemplary embodiments of the disclosed subject matter. Heating blocks 210A-C may comprise at least one heating element 220, tubes 202 and 230 as previously described in FIG. 2 or such as tube 130 of FIG. 1. In some exemplary embodiments, heating block 210A-C may also comprise, as previously described, entry 203, exit 237, nozzles and baffles. Additionally or alternatively, heating block 210A-C may comprise a valve 240 and or an exit valve 250.

In some exemplary embodiments, the heating block 210A-C may be a metal block comprising tubes casted in it. At least one first tube 202 and at least one second tube 230 may be embedded may be casted in a formation that increases the thermal connectivity of the tubes with heating blocks 210A-C. In some exemplary embodiments, second tube 230 and first tube 202 may be wrapped around each other; second tube 230 and first tube 202 assembled parallel to one another; the second tube 230 inserted inside the first tube 202; combination thereof, or the like.

In some exemplary embodiments, the heating block 210A-C may be a metal block having in it channels for fluid passage. The channels may have a maze layout, formed in a way that provides optimal thermal connectivity between the heating block and the fluid passing in the channels. (Additional details were provided in the FIG. 1 description above). It should be noted that at least one channel may be dedicated as hot liquid passage, such as tube 202, and at least one another channel may be dedicated as steam passage, such as tube 230. Similarly, both passages are terminated with exit 207 and 237 respectively.

In some exemplary embodiments, the at least one heating element 220 may be thermally connected to the heating block 210A-C, the second tube 230, first tube 202, a combination thereof, or the like. In some exemplary embodiments, pressurized fluid, such as water, may be routed trough entry 203 and valve 240, into the heating block by either a pump (not shown) or gravitation.

In the heating block 210A topology depicted in FIG. 10A valve 240 is utilized for routing fluids to either first tube 202 or second tube 230. Valve 240 may be a three way valve comprising one inlet (AB) and two outlets (A) and (B). Routing the fluid trough outlet (A) to first tube 202 will yield hot liquid in exit 207 and routing the fluid trough outlet (B) to second tube 230 will yield in exit 237.

The heating block 210B topology depicted in FIG. 10B may be similar to the heating block 210A topology with the exception of having only one exit 237 for both steam and hot water. To do so an exit valve 250 may be used to route either first tube 202 or second tube 230 to exit 237. Exit valve 250 may be a three way valve comprising two inlets (A) and (B) and one outlet (AB). In embodiments where hot liquid is required, the fluid may be routed from entry 203 to exit 237 along the following path: valve 240 (AB); valve 240 (A), first tube 202; exit valve 250 (A) and exit valve 250 (AB). In embodiments where steam is required, the fluid may be routed from entry 203 to exit 237 along the following path: valve 240 (AB); valve 240 (B), second tube 230; exit valve 250 (B) and exit valve 250 (AB).

The heating block 210C topology depicted in FIG. 10C may be an upgraded version of the heating block 210B topology that offers a power saving and concurrent modes. In some exemplary embodiments, the heating block 210C topology further comprises a return valve 260 and a check valve 270 for facilitating power saving capabilities with respect to heating block 210B topology. In addition to the hot liquid and steam modes, such as provided with the heating block 210B topology, the heating block 210C topology may also provide a concurrent mode, i.e., supply of steam and hot water simultaneously, a combination thereof

In hot liquid mode embodiments, the fluid may be routed from entry 203 to exit 237 along the following path: valve 240 (AB); valve 240 (A), first tube 202; return valve 260 (AB); return valve 260 (A) exit valve 250 (A) and exit valve 250 (AB). Note: check valve 270 don't care.

In steam mode embodiments, the fluid may be routed from entry 203 to exit 237 along the following path: valve 240 (AB); valve 240 (B), first tube 202; exit valve 250 (A) and exit valve 250 (AB). Note: return valve 260 don't care and check valve 270 should be disabled

In power saving mode embodiments, the fluid may be routed from entry 203 to exit 272 along the following path: valve 240 (AB); valve 240 (A), first tube 202; return valve 260 (AB); return valve 260 (B); second tube 230 (reheating); check valve 270 in; check valve 270 out and tube 271.

In concurrent mode embodiments, the fluid may be routed from entry 203 and flow along the following path: valve 240 (AB); valve 240 (A), first tube 202; return valve 260 (AB) and return valve 260 (B) where the fluid splits in two directions. One direction, through exit valve 250 (B); exit valve 250 (AB) and exit as hot liquid via exit 237. The other direction, through second tube 230 (reheating); check valve 270 in; check valve 270; tube 271 and exit via exit 237 as steam.

It should be noted that, all the embodiments depicted in FIGS. 10A-C may utilize the nozzles described in the present disclosed subject matter. Furthermore, the electrical setup 480 can be operationally coupled with valves 240, 250, 260 and 270 and may be configured to control the valve's sequence of operation in order to satisfy selection of the modes described above. It should also be noted that, in power saving features the electrical setup 480 may reduce the current to the at least one heater 220. Furthermore, switches and indicators depicted in FIG. 4 may be selectors configured to for selecting, by a user and display the proper status of the steamer. Additionally or alternatively, the valves may be manually set by the user.

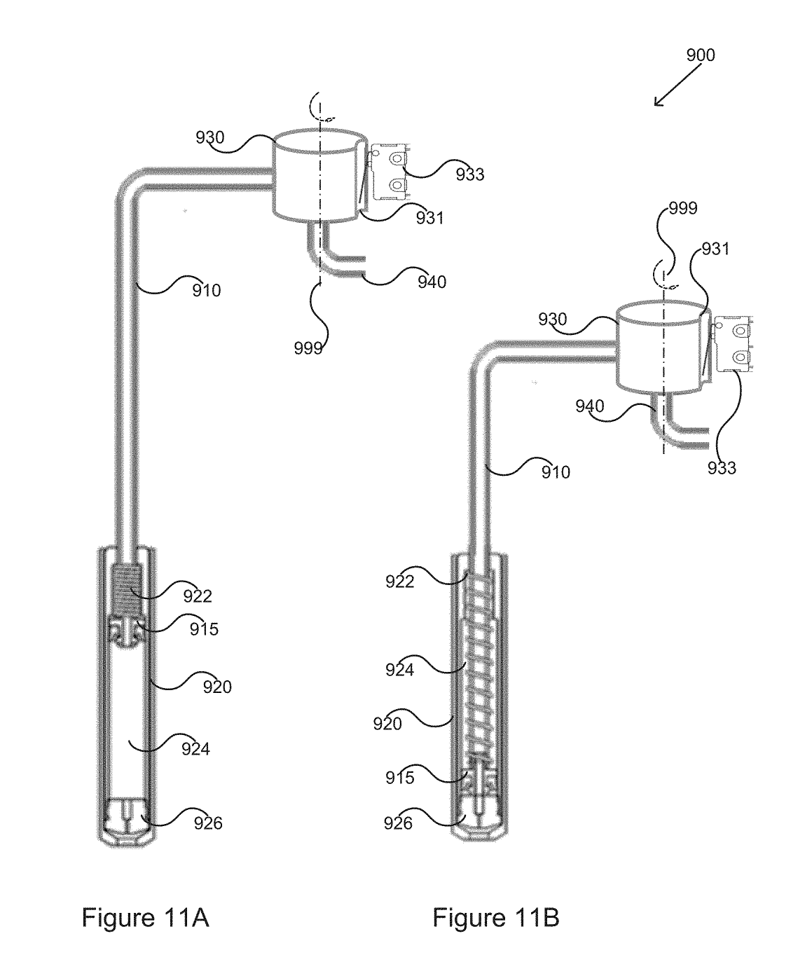

Referring now to FIGS. 11A and 11B illustrating a steam delivery apparatus 900 in extracted and retracted position respectively, in accordance with some exemplary embodiments of the disclosed subject matter. Steam delivery apparatus 900 may be comprised of a spring 922, a piston 915, a cylinder 920, a nozzle 926, a chamber 924, a steam wand 910, a feeder 940, an actuator 930 having a groove 931, and an interlock 933.

In some exemplary embodiments, the steam delivery apparatus 900 may be a part of a kettle, an espresso machine, a samovar, an urn, or the like. When activated the steam delivery apparatus 900 can be used for delivering steam into a container, such as glass or a cup, filled with liquid, such as milk or water, in order to boil the liquid. Users may activate the steam delivery apparatus 900 by swiveling or tilting the steam delivery apparatus 900, around its axis (hinge) 999, away from its resting position. Upon swiveling or tilting apparatus 900, actuator 930 will be rotated, which will cause interlock 933 to come out of groove 931 (resting position), subsequently triggering the electrical setup 480 to activate the steam heater, of the present discloser.

In some exemplary embodiments, upon activation, steam may be supplied trough exits, such as exits 137, 237 and 272 of FIGS. 1, 2 and 10, to actuator 930 via feeder 940. Actuator 930 may channel the steam via steam wand 910 and piston 915 to chamber 920. Subsequently, steam expands inside the chamber, which will result in pressure increase that leads to squeezing spring 922 and extracting cylinder 920 into a liquid container. Consequently, piston 215 will move upward, as shown in FIG. 11A, thereby allowing steam accumulated in chamber 924 to flow out through nozzle 926.

In some exemplary embodiments, the steam delivery apparatus 900 may be deactivated (idle) by swiveling or tilting apparatus 900, back to its resting position or switching off the steam heater. Additionally or alternatively, the steam delivery apparatus 900 may be activated and deactivated manually by pulling down or pushing up cylinder 920. However it will be noted that in such embodiment spring 922 may be removed from the steam delivery apparatus 900. In some exemplary embodiments, the steam delivery apparatus 900 or a portion thereof may be provided in a way that allows users to dismantle it for cleaning and service.

Those skilled in the art will recognize that the method and system of the present invention has many applications, may be implemented in many manners and, as such, is not to be limited by the preceding and following exemplary embodiments and examples. Additionally, the functionality of the components of the preceding and following embodiments may be implemented in different manners. Further, it is to be understood that the steps in the embodiments may be performed in any suitable order, combined into fewer steps or divided into more steps. Thus, the scope of the present invention covers conventionally known and future developed variations and modifications to the system components described herein, as would be understood by those skilled in the art.

1. A steamer having a steam mode and hot liquid mode, incorporated within a drinking liquid appliance comprising:
an electrical setup;
at least one first tube having one first end and one first exit and at least one second tube, having one second end and one second exit;
at least one heating element coupled with the electrical setup, wrapped around tubes selected from a group comprising of: the at least one first tube; the at least one second tube; and a combination thereof;
a steam delivery apparatus, having a nozzle, wherein the steam delivery apparatus is coupled with the electrical setup configured to activate the steamer in the steam mode by rotating the apparatus, wherein the second exit is fluidically connected to the steam delivery apparatus; and
a valve coupled with the electrical setup configured to route fluid to the first end in the hot liquid mode and to the second end in the steam mode; and
wherein fluid routed to the end yield hot liquid via a liquid nozzle connected to the first exit, and wherein fluid routed to the second end yield steam via the second exit..

2. The steamer of claim 1 which further comprises an exit valve, coupled with the electrical setup, configured to route steam to the first exit, in steam mode, and to route hot liquid, to the first exit, in hot liquid mode.

3. The steamer of claim 1 which further comprises a return valve, coupled with the electrical setup, configured to route fluid from the first tube to the second tube and exit through the second end into a check valve configured to provide steam trough a third exit, in a power saving mode, and wherein the third exit is fluidically connected to the steam delivery apparatus.

4. The steamer of claim 3, wherein the exit valve is configured to provide hot liquid trough the first exit while steam is simultaneously provided through the third exit, in concurrent mode.

5. The steamer of claim 1 which further comprises a pump capable of pressurizing fluid through an entry to the valve, wherein the pump is coupled with the electrical setup.

6. The steamer of claim 1, wherein the at least first tube and the at least second tube are cast within a heating block, wherein the first and second tubes are thermally connected to the heating block, wherein the at least one heating element is thermally connected to the heating block and wherein the heater has a heating capacity sufficient to convert water entering the second tube into steam leaving via the second exit.

7. The steamer of claim 6, wherein the tubes are cast within the heating block in a formation that provides optimal thermal connectivity, and wherein the formation is selected from the group consisting of the second tube wrapped around the first tube; the second tube inserted within the first tube; the second tube and the first tube are parallel to one another; and a combination thereof.

8. The steamer of claim 1, wherein the steam delivery apparatus is connected to the steamer by a hinge and wherein the steam delivery apparatus can be inserted within a dent in the body of the steamer and being rotated outwardly.

9. The steamer of claim 1 which further comprises a protecting thermostats-based mechanism mutually operable with the electric setup.

10. The steamer of claim 9, wherein the protecting thermostats-based mechanism provides functions selected from the group consisting of security function in which the system is disconnected from electricity; maintaining temperature of fluid inside the at least one first tube at about 65 degrees C.; maintaining temperature of fluid inside the at least one second tube at about 99 degrees C.; and a combination thereof.

11. The steamer of claim 1 which further comprises a plurality of indicators coupled with the electrical setup, wherein indicators of the plurality of indicators are configured to indicate a status of the steamer and wherein the status is selected from the group consisting of steam mode; hot liquid mode; power saving mode; concurrent mode; power on; steamer ready; and a combination thereof.

12. The steamer of claim 1, wherein the steamer is an integral part of a water heating container selected from the group consisting of an urn; a kettle; a coffee maker; an espresso machine; and a combination thereof and wherein hot liquid exits into the container.

13. A steamer having a steam mode and hot liquid mode, incorporated within a drinking liquid appliance comprising:
an electrical setup;
a heating block having a first fluid passage and a second fluid passage, wherein the first and the second passages are formed as a maze inside the heating block and wherein the first passage has a first end and a first exit and the second passage has a second end and a second exit;
at least one heating element, coupled with the electrical setup, thermally connected to the heating block, and wherein the heater has a heating capacity sufficient to convert fluid in the second passage into steam;
a steam delivery apparatus, having a nozzle, wherein the steam delivery apparatus is coupled with the electrical setup configured to activate the steamer in the steam mode by rotating the apparatus, wherein the second exit is fluidically connected to the steam delivery apparatus; and
a valve coupled with the electrical setup configured to route fluid to the first end in the hot liquid mode and to the second end in the steam mode; and
wherein fluid routed to the first end yield hot liquid via a liquid nozzle connected to the first exit, and wherein fluid routed to the second end yield steam via the second exit.

14. The steamer of claim 13, further comprising baffles within the passages to provide optimal thermal connectivity with the fluid.

15. The steamer of claim 14 which further comprises an exit valve, coupled with the electrical setup, configured to route steam to the first exit, in steam mode, and to route hot liquid, to the first exit, in hot liquid mode.

16. The steamer of claim 14 which further comprises a return valve, coupled with the electrical setup, configured to route fluid from the first passage to the second passage and exit trough the second end into a check valve configured to provide steam trough a third exit, in a power saving mode, and wherein the third exit is fluidically connected to the steam delivery apparatus.

17. The steamer of claim 16, wherein the exit valve is configured to provide hot liquid trough the first exit while steam is simultaneously provided through the third exit, in concurrent mode.

18. The steamer of claim 14 which further comprises a pump capable of pressurizing fluid trough an entry into the valve, wherein the pump is coupled with the electrical setup.

19. The steamer of claim 14 which further comprises a protecting thermostats-based mechanism mutually operable with the electric setup, wherein the protecting thermostats-based mechanism provides functions selected from the group consisting of security function in which the system is disconnected from electricity; maintaining temperature of fluid inside the at least one first passage at about 65 degrees C.;
maintaining temperature of fluid inside the at least one second passage at about 99 degrees C.; and a combination thereof.

20. The steamer of claim 14 which further comprises a plurality of indicators coupled with the electrical setup, wherein indicators of the plurality of indicators are configured to indicate a status of the steamer and wherein the status is selected from the group consisting of steam mode; hot liquid mode; power saving mode; concurrent mode; power on; steamer ready; and a combination thereof.
